(19) United States
(12) Patent Application Publication
(10) Pub. No.: US 2026/0142075 A1
(43) Pub. Date: May 21, 2026

(54) COIL ELECTRONIC COMPONENT

(71) Applicant: SAMSUNG ELECTRO-MECHANICS CO., LTD., Suwon-si (KR)

(72) Inventors: Han Lee, Suwon-si (KR); Boumseock Kim, Suwon-si (KR)

(73) Assignee: SAMSUNG ELECTRO-MECHANICS CO., LTD., Suwon-si (KR)

(21) Appl. No.: 19/087,041

(22) Filed: Mar. 21, 2025

(30) Foreign Application Priority Data
Nov. 18, 2024 (KR) 10-2024-0163818

(51) Int. Cl. H01F 27/34; H01F 27/30

(52) U.S. Cl. CPC H01F 27/346; H01F 27/306

(57) ABSTRACT

A coil electronic component includes: a body including a magnetic material, four or more coils embedded in the body, and a gap portion comprising a glass material disposed in at least one of regions between adjacent coiling in the four or more coils.

### CROSS-REFERENCE TO RELATED APPLICATION

This application claims priority to and the benefit of Korean Patent Application No. 10-2024-0163818 filed in the Korean Intellectual Property Office on Nov. 18, 2024, the entire contents of which are incorporated herein by reference.

### BACKGROUND

### 1. Field

The present disclosure relates to a coil electronic component.

### 2. Description of the Related Art

An inductor, a type of coil electronic component, is a representative passive element configuring an electronic circuit, together with a resistor and a capacitor, to remove noise, and is combined with such a capacitor using electromagnetism to provide a resonance circuit amplifying a signal in a specific frequency band, a filter circuit, or the like.

In addition, power consumption is increasing as miniaturization and high performance of electronic devices are required. Due to this increase in power consumption, the switching frequency of power management integrated circuit (PMIC) or DC-DC converter used in the power circuit of electronic devices is becoming higher, the output current is increasing, and the use of power inductors used to stabilize the output current of PMIC or DC-DC converter is increasing.

Demand for an array-type inductor having the advantage of reducing a mounting area is also increasing. Array-type inductors include a plurality of coils disposed adjacent to each other, and it is necessary to reduce the inductance deviation between the coils.

### SUMMARY

An aspect of an embodiment provides a coil electronic component that may reduce inductance deviation between coils.

However, the objective of the present disclosure is not limited to the aforementioned one, and may be extended in various ways within the spirit and scope of the present disclosure.

An embodiment provides a coil electronic component, including: a body including a magnetic material, four or more coils embedded in the body, and a gap portion comprising a glass material disposed in at least one of regions between the coils.

The gap portion may include a surface flush with an outer surface of the body.

The coils may include a first coil, a second coil, a third coil, and a fourth coil that are spaced apart from each other, the gap portion may include at least one of a first gap portion, a second gap portion, and a third gap portion, the first gap portion may be disposed in a first region between the first coil and the second coil, the second gap portion may be disposed in a second region between the second coil and the third coil, and the third gap portion may be disposed in at least one region of a third region between the third coil and the fourth coil.

Each of the first gap portion, the second gap portion, and the third gap portion may include a surface flush with an outer surface of the body.

The first gap portion, the second gap portion, and the third gap portion may all be spaced apart from an outer surface of the body.

The coils may include a first coil, a second coil, a third coil, and a fourth coil that are spaced apart from each other, and the gap portion may include a first gap portion disposed in a first region between the first coil and the second coil, and a third gap portion disposed in a third region between the third coil and the fourth coil, and each of the first gap portion and the third gap portion may include a surface flush with an outer surface of the body.

The coils may include a first coil, a second coil, a third coil, and a fourth coil that are spaced apart from each other, and the gap portion may include a first gap portion disposed in a first region between the first coil and the second coil, and a third gap portion disposed in a third region between the third coil and the fourth coil, and both the first gap portion and the third gap portion may be spaced apart from an outer surface of the body.

The coil may include a first coil, a second coil, a third coil, and a fourth coil that are spaced apart from each other, and the gap portion may be disposed in a second region between the second coil and the third coil, and may include a surface flush with an outer surface of the body.

the coil may include a first coil, a second coil, a third coil, and a fourth coil that are spaced apart from each other, and the gap portion may be disposed in a second region between the second coil and the third coil and may be spaced apart from the outer surface of the body.

The coil electronic component may further include a first support member, a second support member, a third support member, and a fourth support member that are embedded in the body and spaced apart from each other, wherein the coils may include a first coil, a second coil, a third coil, and a fourth coil that are spaced apart from each other, the first coil may be disposed on the first support member, the second coil may be disposed on the second support member, the third coil may be disposed on the third support member, and the fourth coil may be disposed on the fourth support member.

The first coil may include two coil patterns disposed on one surface and the other surface of the first support member, respectively, and connected to each other through a via penetrating the first support member, the second coil may include two coil patterns disposed on one surface and the other surface of the second support member, respectively, and connected to each other through a via penetrating the second support member, the third coil may include two coil patterns disposed on one surface and the other surface of the third support member, respectively, and connected to each other through a via penetrating the third support member, and the fourth coil may include two coil patterns disposed on one surface and the other surface of the fourth support member, respectively, and connected to each other through a via penetrating the fourth support member.

The body may be a laminate in which a plurality of magnetic sheets is stacked, the coils may include a first coil, a second coil, a third coil, and a fourth coil that are spaced apart from each other, and each of the first coil, the second coil, the third coil, and the fourth coil may include a plurality of conductor patterns disposed on each magnetic sheet of the plurality of magnetic sheets and connected to each other.

The coils may include a first coil, a second coil, a third coil, and a fourth coil that are spaced apart from each other, and each of the first coil, the second coil, the third coil, and the fourth coil may include at least one turn of a conductive wire.

The body may include a first core penetrating the first coil, a second core penetrating the second coil, a third core penetrating the third coil, and a fourth core penetrating the fourth coil.

The coil electronic component may further include an insulating film disposed on a surface of the conductive wire.

The relative magnetic permeability of the gap portion may be 1 or more and 3 or less.

The coil electronic component may further include a plurality of external electrodes disposed outside the body and connected to the four or more coils.

The plurality of external electrodes may include metal.

The plurality of external electrodes may include metal and glass.

The coil electronic component may further include a surface insulating layer covering at least a portion of a surface of the body.

An embodiment provides coil electronic component including: a body including a plurality of magnetic sheets stacked together, a plurality of coils embedded in the body, wherein each respective coil in the plurality of coils includes a plurality of corresponding conductor patterns disposed on the plurality of magnetic sheets and electrically connected to each other, and (ii) for each respective coil in the plurality of coils, at least three conductor patterns in the plurality of corresponding conductor patterns are different from each other in shape, and one or more gap portions, each including a glass material disposed in a region between adjacent coils in the plurality of coils.

Coils in the plurality of coils may be substantially identical.

The plurality of coils may include first, second, third and fourth coils, and the one or more gap portions may include a first gap portion disposed between the first and second coils, a second gap portion disposed between the second and third coils, and a third gap portion disposed between the third and fourth coils.

The plurality of corresponding conductor patterns may include: a first conductor pattern in a substantially J-shape with an end exposed to a surface of the body, a second conductor pattern in a substantially U-shape, and a third conductor pattern in a substantially C-shape.

The plurality of corresponding conductor patterns may further include a fourth conductor pattern in a substantially reverted U-shape a fifth conductor pattern in a substantially reverted C-shape, a sixth conductor pattern substantially the same as the second conductor pattern, a seventh conductor pattern substantially the same as the third conductor pattern, an eighth conductor pattern substantially the same as the fourth conductor pattern, and a ninth conductor pattern in a substantially reverted J-shape with an end exposed to an opposite surface of the body.

The plurality of corresponding conductor patterns may include nine or more conductor patterns.

The body may further include two additional magnetic sheets, wherein the plurality of magnetic sheets is disposed between the two additional magnetic sheets.

According to one or more embodiments, a coil electronic component capable of reducing inductance deviation between a plurality of coils disposed adjacent to each other may be provided.

### BRIEF DESCRIPTION OF THE DRAWINGS

FIG. 1 schematically illustrates a perspective view of a coil electronic component according to an embodiment.

FIG. 2 illustrates a top plan view of FIG. 1.

FIG. 3 illustrates a schematic cross-sectional view taken along line I-I′ of FIG. 1.

FIG. 4 illustrates a schematic diagram of the flow of a magnetic flux of the coil electronic component of FIG. 1.

FIG. 5 schematically illustrates a cross-sectional view of a coil electronic component according to another embodiment.

FIG. 6 schematically illustrates a cross-sectional view of a coil electronic component according to another embodiment.

FIG. 7 schematically illustrates a cross-sectional view of a coil electronic component according to another embodiment.

FIG. 8 schematically illustrates a cross-sectional view of a coil electronic component according to another embodiment.

FIG. 9 schematically illustrates a cross-sectional view of a coil electronic component according to another embodiment.

FIG. 10 schematically illustrates a perspective view of a coil electronic component according to another embodiment.

FIG. 11 illustrates a top plan view of FIG. 10.

FIG. 12 illustrates an exploded perspective view of a body of the coil electronic component of FIG. 10.

FIG. 13 illustrates a schematic cross-sectional view taken along line II-II′ of FIG. 11.

FIG. 14 schematically illustrates a perspective view of a coil electronic component according to another embodiment.

FIG. 15 illustrates a schematic cross-sectional view taken along line III-III′ of FIG. 14.

### DETAILED DESCRIPTION

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including an ordinal number, such as first, second, etc., may be used to describe various elements, but the elements are not limited by the terms. These terms are only used to differentiate one constituent element from another. It should be understood that when an element such as a layer, film, region, area or substrate is referred to as being “on” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

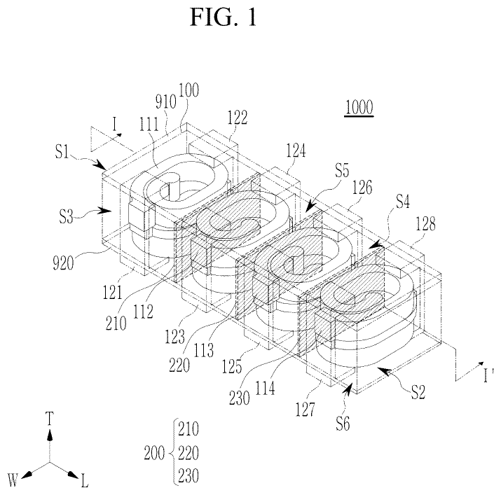

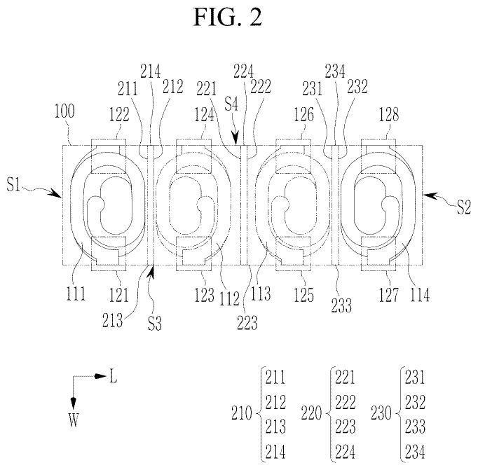

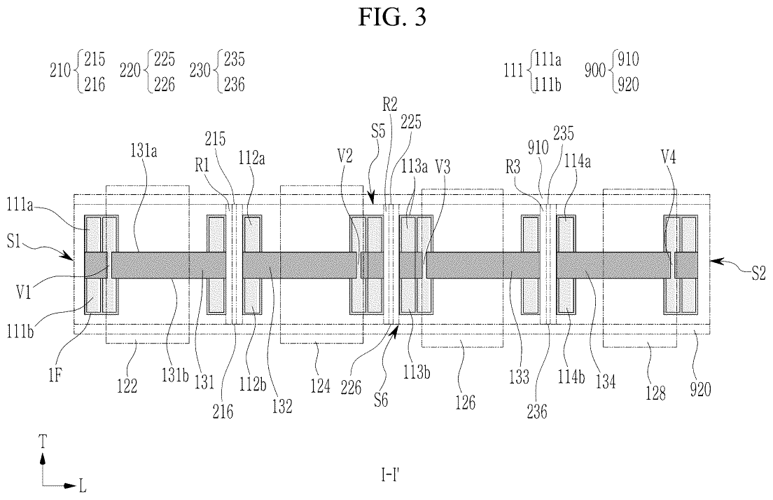

FIG. 1 schematically illustrates a perspective view of a coil electronic component according to an embodiment, FIG. 2 illustrates a top plan view of FIG. 1, and FIG. 3 illustrates a schematic cross-sectional view taken along line I-I′ of FIG. 1.

Referring to FIG. 1, FIG. 2, and FIG. 3, a coil electronic component 1000 according to an embodiment corresponds to an array-type inductor that includes a plurality of coils 111, 112, 113, and 114 spaced apart from each other.

The coil electronic component 1000 includes first to fourth coils 111, 112, 113, and 114, but the present embodiment is not limited thereto. For example, a coil electronic component that includes more than four coils or less than four coils may be provided, if needed.

The coil electronic component 1000 includes a body 100, a plurality of external electrodes 121, 122, 123, 124, 125, 126, 127, and 128 disposed on the outer surface of the body 100, a plurality of coils 111, 112, 113, and 114 embedded in the body 100, and a gap portion 200.

The body 100 may have a substantially rectangular hexahedral shape, but the present embodiment is not limited thereto. Due to shrinkage of magnetic powder or the like during sintering, the body 100 may not have a perfect rectangular hexahedral shape, but may have a substantially rectangular hexahedral shape. For example, the body 100 has a substantially rectangular hexahedral shape, but corner or vertex portions may have a rounded shape.

In the present embodiment, for better understanding and ease of description, two surfaces opposing in the length direction (L-axis direction) of the coil electronic component 1000 are defined as a first surface S1 and a second surface S2, two surfaces opposing in the width direction (W-axis direction) of the coil electronic component 1000 are defined as a third surface S3 and a fourth surface S4, and two surfaces opposing in the thickness direction (T-axis direction) of the coil electronic component 1000 are defined as a fifth surface S5 and a sixth surface S6, respectively.

A length of the coil electronic component 1000 may mean, based on an optical microscope or scanning electron microscope (SEM) photograph of a cross-section in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the length direction (L-axis direction) of the coil electronic component 1000 shown in the above cross-sectional photograph and are parallel to the length direction (L-axis direction). Alternatively, the length of the coil electronic component 1000 may mean a minimum value of lengths of a plurality of line segments that connect two outermost boundary lines facing each other in the length direction (L-axis direction) of the coil electronic component 1000 shown in the above cross-sectional photograph and are parallel to the length direction (L-axis direction).

Alternatively, the length of the coil electronic component 1000 may mean an arithmetic average value of lengths of at least two of a plurality of line segments that connect two outermost boundary lines facing each other in the length direction (L-axis direction) of the coil electronic component 1000 shown in the above cross-sectional photograph and are parallel to the length direction (L-axis direction).

A thickness of the coil electronic component 1000 may mean, based on an optical microscope or scanning electron microscope (SEM) photograph of a cross-section in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean a minimum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean an arithmetic average value of lengths of at least two of a plurality of line segments that connect two outermost boundary lines facing each other in the thickness direction (T-axis direction) of the coil electronic component 1000 shown in the above cross-sectional photograph and are parallel to the thickness direction (T-axis direction).

A width of the coil electronic component 1000 may mean, based on an optical microscope or scanning electron microscope (SEM) photograph of a cross-section in the length direction (L-axis direction)-the width direction (W-axis direction) at a center of the coil electronic component 1000 in the thickness direction (T-axis direction), a maximum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean a minimum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean an arithmetic average value of lengths of at least two of a plurality of line segments that connect two outermost boundary lines facing each other in the width direction (W-axis direction) of the coil electronic component 1000 shown in the above cross-sectional photograph and are parallel to the width direction (W-axis direction).

Each of the length, the width, and the thickness of the coil electronic component 1000 may be measured by a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and thickness of the coil electronic component 1000.

The body 100 includes a plurality of coils 111, 112, 113, and 114 spaced apart from each other in the length direction (L-axis direction) and a gap portion 200.

The plurality of coils 111, 112, 113, and 114 may have substantially the same shape. Here, the disclosure that the plurality of coils has the same shape means that the line width, thickness, and number of windings of coil patterns of each coil are substantially the same. In FIG. 1 to FIG. 3, the number of windings of the coil is represented by about 1.5 turns for convenience of description, but the present embodiment is not limited thereto, and may be appropriately selected by a person skilled in the art in consideration of electrical characteristics such as required inductance and direct current resistance (Rdc).

The body 100 constitutes an exterior of the coil electronic component 1000, and is or provides a space where a magnetic path, which is a path through which the magnetic flux generated by the first to fourth coil 111, 112, 113, and 114 passes, is formed, when a current is applied to the first to fourth coil 111, 112, 113, and 114 through the plurality of external electrodes 121, 122, 123, 124, 125, 126, 127, and 128.

The body 100 surrounds and encapsulates the first to fourth coils 111, 112, 113, and 114 and the first to fourth support members 131, 132, 133, and 134, and includes a magnetic material. The body 100 includes magnetic particles, and an insulating material may be interposed between the magnetic particles.

The magnetic material may include a first metal magnetic particle, a second metal magnetic particle having a smaller particle size than the first metal magnetic particle, and a third metal magnetic particle having a smaller particle size than the second metal magnetic particle. An average particle diameter D₅₀ of the first metal magnetic particle may be 5 μm or more and 30 μm or less, and an average particle diameter D₅₀ of the second metal magnetic particle may be 1 μm or more and 5 μm or less, and an average particle diameter D₅₀ of the third metal magnetic particle may be 0.05 μm or more and 0.5 μm or less.

The magnetic particle may be ferrite particles or metal magnetic particles exhibiting magnetic characteristics.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrite.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particle may be amorphous or crystalline. For example, the metal magnetic particles may be an Fe—Si—B—Cr-based amorphous alloy, but the present embodiment is not limited thereto. The metal magnetic particles may have an average particle diameter in a range from about 0.1 μm to about 30 μm, but are not limited thereto.

In the present disclosure, the average particle diameter may mean a particle size distribution expressed by D₉₀, D₅₀, or the like. The particle size distribution is well known to those skilled in the art as an index indicating what size (particle diameter) particles are included in what proportion in a particle group to be measured. D₅₀ (a particle diameter corresponding to 50% of a cumulative volume of the particle size distribution) refers to an average particle diameter.

The metal magnetic particle may be two or more types of different metal magnetic particles. Here, by different types of metal magnetic particles it is meant that the metal magnetic particles are distinguished from each other in at least one of an average particle diameter, composition, component ratio, crystallinity, and shape.

The insulating material may include epoxy, polyimide, and liquid crystal polymer, etc. alone or in combination, but is not limited thereto.

The coils 111, 112, 113, and 114 are embedded in the body 100 to exhibit the characteristics of the coil electronic component 1000. For example, when the coil electronic component 1000 of the present embodiment is used as a power inductor, when a current is applied to the coils 111, 112, 113, and 114, the coils may serve to stabilize the power supply of an electronic device by storing energy in the form of a magnetic field maintaining an output voltage.

Starting with the first coil 111 closest to the first surface S1 of the body 100, the second coil 112, the third coil 113, and the fourth coil 114 are sequentially disposed in the length direction (L-axis direction). Therefore, the fourth coil 114 is disposed closest to the second surface S2 of the body 100, and the second coil 112 and the third coil 113 are disposed between the first coil 111 and the fourth coil 114.

The respective winding axes of the first coil 111, the second coil 112, the third coil 113, and the fourth coil 114 may be parallel to the thickness direction (T-axis direction) of the body 100.

The first coil 111 is connected to the first external electrode 121 and the second external electrode 122, which are disposed to be spaced apart from each other in the width direction (W-axis direction) of the body 100, and the second coil 112 is connected to the third external electrode 123 and the fourth external electrode 124, which are disposed to be spaced apart from each other in the width direction (W-axis direction) of the body 100.

The third coil 113 is connected to the fifth external electrode 125 and the sixth external electrode 126, which are spaced apart from each other in the width direction (W-axis direction) of the body 100, and the fourth coil 114 is connected to the seventh external electrode 127 and the eighth external electrode 128, which are spaced apart from each other in the width direction (W-axis direction) of the body 100.

The first to eighth external electrodes 121, 122, 123, 124, 125, 126, 127, and 128 extend from the third surface S3 or the fourth surface S4 of the body 100 to cover a portion of the fifth surface S5 and a portion of the sixth surface S6, but the present embodiment is not limited thereto. For example, the first to eighth external electrodes 121, 122, 123, 124, 125, 126, 127, and 128 may be disposed only on the third surface S3 or the fourth surface S4 of the body 100, or may extend from the third surface S3 or the fourth surface S4 to cover only a portion of the sixth surface S6.

For example, the first to eighth external electrodes 121, 122, 123, 124, 125, 126, 127, and 128 may include a conductive material such as copper (Cu), aluminum (Al), silver (Ag), tin (Sn), gold (Au), nickel (Ni), lead (Pb), chromium (Cr), titanium (Ti), or an alloy thereof, but are not limited thereto.

As another example, the first to eighth external electrodes 121, 122, 123, 124, 125, 126, 127, and 128 may include a conductive metal and glass. The conductive metal may be, for example, a conductive metal including copper (Cu), nickel (Ni), tin (Sn), palladium (Pd), platinum (Pt), gold (Au), silver (Ag), tungsten (W), titanium (Ti), lead (Pb), or an alloy thereof. The glass component included in the external electrode may be a mixture of oxides. The glass component may include, for example, a silicon oxide, a boron oxide, an aluminum oxide, a transition metal oxide, an alkali metal oxide, an alkaline-earth metal oxide, or a combination thereof. Here, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba). The method of forming the external electrodes may not be particularly limited. For example, it may be formed by dipping a body in a conductive paste containing a conductive metal and glass, or by printing a conductive paste on the surface of the body by, e.g., screen printing or gravure printing method. In addition, various methods, such as applying a conductive paste on the surface of a body or transferring a dry film formed by drying a conductive paste to a body, may be used.

Referring to FIG. 3, the first coil 111 is disposed on the first support member 131. The first coil 111 includes an upper coil 111a disposed on an upper surface 131a of the first support member 131 and a lower coil 111b disposed on a lower surface 131b of the first support member 131. The upper coil 111a and the lower coil 111b are connected to each other through a first via V1 penetrating the first support member 131.

The first support member 131 may be made of an insulating material including a thermosetting insulating resin such as an epoxy resin, a thermoplastic insulating resin such as a polyimide, or a photosensitive insulating resin, or may be formed by impregnating a reinforcing material such as glass fiber or inorganic filler in the insulating resin. For example, the support member may be made of an insulating material such as Prepreg, ABF (Ajinomoto Build-up Film), FR-4, BT (Bismaleimide Triazine) film, or PID (Photo Imageable Dielectric) film, but the present embodiment is not limited thereto.

At least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used as the inorganic filler.

Each of the first coil 111 and the first via V1 may be made of a conductive material such as copper (Cu), aluminum (AI), silver (Ag), tin (Sn), gold (Au), nickel (Ni), lead (Pb), titanium (Ti), or an alloy thereof, but the present embodiment is not limited thereto.

An insulating film IF may be disposed between the first coil 111 and the body 100. The insulating film IF may be formed along the surface of the first support member 131 and the surface of the first coil 111. The insulating film IF does not exist in a portion where the first support member 131 and the first coil 111 are connected to the first external electrode 121 and the second external electrode 122. The insulating film IF is for insulating the first coil 111 from the body 100 and may include a known insulating material such as parylene. Any insulating material may be used in the insulating film IF, and there is no particular limitation. For example, the insulating layer IF may be a polyurethane resin, a polyester resin, an epoxy resin, or a polyamideimide resin. The insulating film IF may be formed by a method such as vapor deposition, but is not limited thereto. For example, the insulating film IF may be formed by stacking insulating films on both surfaces of the first support member 131.

The second coil 112, the third coil 113, and the fourth coil 114 differ from the first coil 111 only in their locations, so redundant descriptions thereof will be omitted.

Meanwhile, a surface insulating layer 900 may be disposed on the fifth surface S5 and the sixth surface S5 of the body 100.

The surface insulating layer 900 includes a first insulating layer 910 and a second insulating layer 920. The first insulating layer 910 is disposed on the fifth surface S5 of the body 100, and the second insulating layer 920 is disposed on the sixth surface S6 of the body 100.

The surface insulating layer 900 may partially cover the fifth and sixth surfaces S5 and S6 of the body 100. That is, the first to eighth external electrodes 121, 122, 123, 124, 125, 126, 127, and 128 are disposed on the fifth and sixth surfaces S5 and S6 of the body 100, and the surface insulating layer 900 may not cover the first to eighth external electrodes 121, 122, 123, 124, 125, 126, 127, and 128.

In other embodiments, the surface insulating layer 900 may also be disposed on at least one of the first surface S1, the second surface S2, the third surface S3, and the fourth surface S4 of the body 100.

The surface insulating layer 900 may prevent current leakage between the first to eighth external electrodes 121, 122, 123, 124, 125, 126, 127, and 128.

For example, the surface insulating layer 900 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, and the like, a thermosetting resin such as a phenol-based resin, an epoxy-based resin, a urethane-based resin, a melamine-based resin, an alkyd-based resin, a photosensitive resin, parylene, SiOₓ, or SiNₓ.

The surface insulating layer 900 may be formed through a process such as screen printing, pad printing, dipping, spray printing, or the like. For example, the surface insulating layer 900 may be formed by applying a liquid insulating resin to a surface of the body 100, or by stacking an insulating film such as a dry film on the surface of the body 100, or through a thin film process such as vapor deposition. In the case where the surface insulating layer 900 is formed of an insulating film, the insulating film may be an ABF (Ajinomoto Build-up Film) or a polyimide film, or the like, which do not include a photosensitive insulating resin.

When four coils are disposed in an array structure, such as in the present embodiment, interference may occur between the coils, changing the inductance characteristics of the coil electronic component.

Because the second coil 112 and the third coil 113 are disposed between the first coil 111 and the fourth coil 114, the inductance of the second coil and the third coil may significantly increase under the influence of the magnetic flux generated by the first coil 111 and the fourth coil 114. In this case, the inductance deviation between the coils may increase. As the inductance deviation increases, that is, as the deviation of the coefficient of coupling increases, leakage inductance exists, which may affect the resonance frequency, and thus may cause difficulties in circuit design.

According to the present embodiment, the inductance deviation may be reduced by disposing a gap portion 200 having a magnetic permeability smaller than that of the body 100 between the coils 111, 112, 113, and 114.

For example, the relative magnetic permeability of the gap portion 200 may have a value close to 1, that is, a value of 1 or more and 3 or less.

The gap portion 200 may be made of glass. For example, the gap portion 200 may include B₂O₃—SiO₂-based glass, Al₂O₃—SiO₂-based glass, and the like, but the present embodiment is not limited thereto.

If the relative magnetic permeability of the gap portion 200 is low compared to that of the body 100, it is difficult for the magnetic flux to pass through the gap portion 200, which may reduce the mutual inductance of the coils adjacent to each other with the gap 200 therebetween.

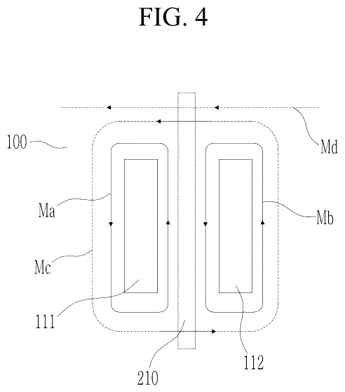

FIG. 4 illustrates a schematic diagram of the flow of a magnetic flux of the coil electronic component of FIG. 1.

Referring to FIG. 4, magnetic fluxes generated by the first coil 111 and the second coil 112 are magnetic flux Ma, magnetic flux Mb, magnetic flux Mc, and magnetic flux Md.

The magnetic flux Ma passes through a magnetic path surrounding the first coil 111 and the magnetic flux Mb passes through a magnetic path surrounding the second coil 112.

The magnetic flux Mc passes through a magnetic path that simultaneously surrounds the first coil 111 and the second coil 112. The magnetic flux Md passes through a magnetic path surrounding the first coil 111, the second coil 112, the third coil 113 (see FIG. 3), and the fourth coil 114 (see FIG. 3). Because the first gap portion 210 is disposed in the magnetic path through which the magnetic flux Mc and the magnetic flux Mad pass, the magnetic flux Mc and the magnetic flux Md are reduced by the first gap portion 210.

As described above, according to the present embodiment, the magnetic fluxes (for example, the magnetic flux Mc and the magnetic flux Md) that cross between the different coils are reduced by the gap portion 200. The magnetic flux affecting the second coil 112 and the third coil 113, which are the innermost of the four coils 111, 112, 113, and 114, is also reduced. Compared to the case where no gap portion is disposed between the coils, the inductance increase rate of the second coil 112 and the third coil 113 with respect to the inductance of the first coil 111 is relatively reduced.

The gap portion 200 may be disposed in at least one of a first region R1 between the first coil 111 and the second coil 112, a second region R2 between the second coil 112 and the third coil 113, and a third region R3 between the third coil 113 and the fourth coil 114.

For example, the gap portion 200 may include a first gap portion 210, a second gap portion 220, and a third gap portion 230.

The first gap portion 210 is disposed in the first region R1 between the first coil 111 and the second coil 112.

The second gap portion 220 is disposed in the second region R2 between the second coil 112 and the third coil 113.

The third gap portion 230 is disposed in the third region R3 between the third coil 113 and the fourth coil 114.

The first gap portion 210 may have a substantially plate-like shape. For example, the first gap portion 210 may include a first main surface 211, a second main surface 212, a first side surface 213, a second side surface 214, a third side surface 215, and a fourth side surface 216.

The first main surface 211 faces the first coil 111 and the second main surface 212 faces the second coil 112. The first main surface 211 and the second main surface 212 are opposite each other in the length direction (L-axis direction).

The first side surface 213 and the second side surface 214 are opposite each other in the width direction (W-axis direction), and the third side surface 215 and the fourth side surface 216 are opposite each other in the thickness direction (T-axis direction).

The first side surface 213 may be flush with the third surface S3 of the body 100, and the second side surface 214 may be flush with the fourth surface S4 of the body 100.

The third side surface 215 may be flush with the fifth surface S5 of the body 100, and the fourth side surface 216 may be flush with the sixth surface S6 of the body 100.

The second gap portion 220 may have a substantially plate-like shape. For example, the second gap portion 220 may include a first main surface 221, a second main surface 222, a first side surface 223, a second side surface 224, a third side surface 225, and a fourth side surface 226.

The third gap portion 230 may have a substantially plate-like shape. For example, the third gap portion 230 may include a first main surface 231, a second main surface 232, a first side surface 233, a second side surface 234, a third side surface 235, and a fourth side surface 236.

The second gap portion 220 and the third gap portion 230 have the same structure as the first gap portion 210 except for their locations, so redundant descriptions thereof will be omitted.

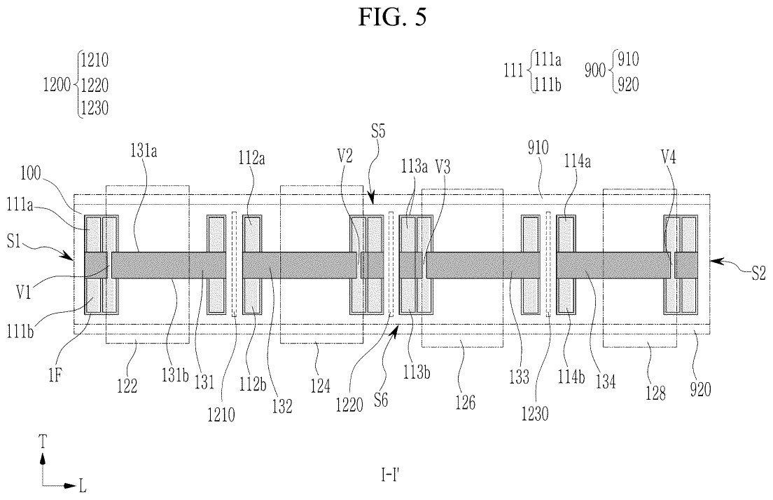

FIG. 5 schematically illustrates a cross-sectional view of a coil electronic component according to another embodiment.

Referring to FIG. 5, a gap portion 1200 includes a first gap portion 1210, a second gap portion 1220, and a third gap portion 1230.

The first gap portion 1210, the second gap portion 1220, and the third gap portion 1230 are all spaced apart from the outer surface of the body 100 and are disposed within the body 100.

The remaining components are identical to the components of the coil electronic component shown in FIG. 1, so redundant descriptions thereof will be omitted.

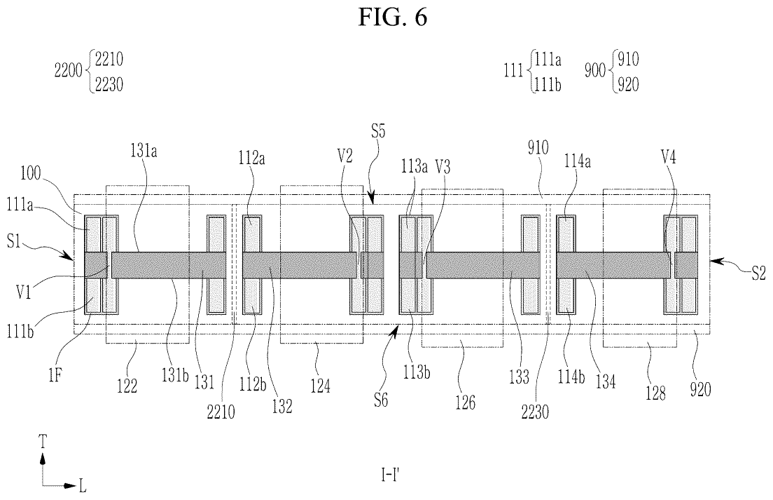

FIG. 6 schematically illustrates a cross-sectional view of a coil electronic component according to another embodiment.

Referring to FIG. 6, a gap portion 2200 includes a first gap portion 2210 and a third gap portion 2230.

No other gap portion is disposed between the first gap portion 2210 and the third gap portion 2230. That is, no gap portion is disposed between the second coil 112 and the third coil 113.

The remaining components are identical to the components of the coil electronic component shown in FIG. 1, so repeated descriptions thereof will be omitted.

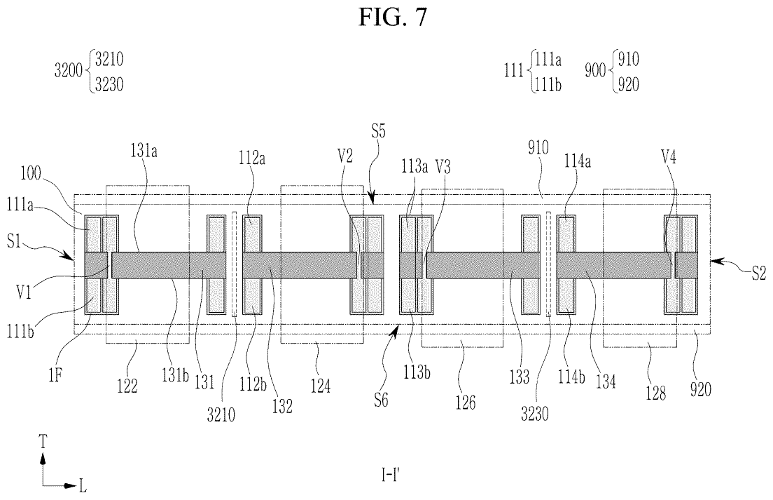

FIG. 7 schematically illustrates a cross-sectional view of a coil electronic component according to another embodiment.

Referring to FIG. 7, a gap portion 3200 includes a first gap portion 3210 and a third gap portion 3230.

The first gap portion 3210 and the third gap portion 3230 are spaced apart from the outer surface of the body 100 and are disposed within the body 100.

The remaining components are identical to the components of the coil electronic component shown in FIG. 6, so redundant descriptions thereof will be omitted.

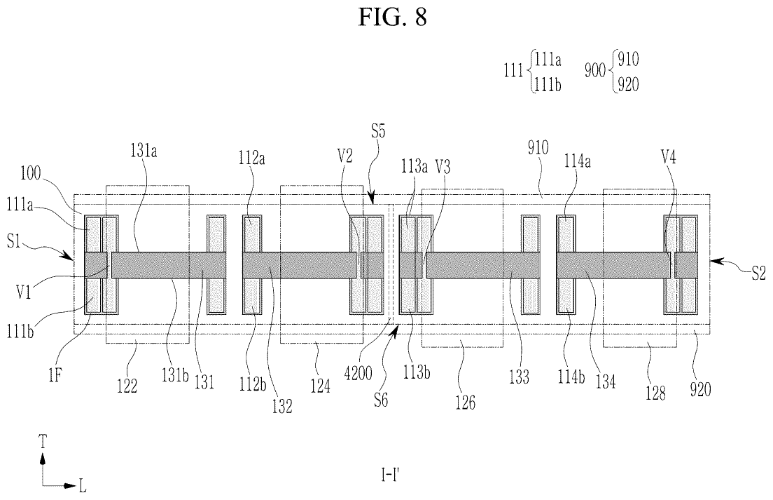

FIG. 8 schematically illustrates a cross-sectional view of a coil electronic component according to another embodiment.

Referring to FIG. 8, a gap portion 4200 is disposed between the second coil 112 and the third coil 113. No gap portions are disposed between the first coil 111 and the second coil 112 and between the third coil 113 and the fourth coil 114.

The remaining components are identical to the components of the coil electronic component shown in FIG. 1, so redundant descriptions thereof will be omitted.

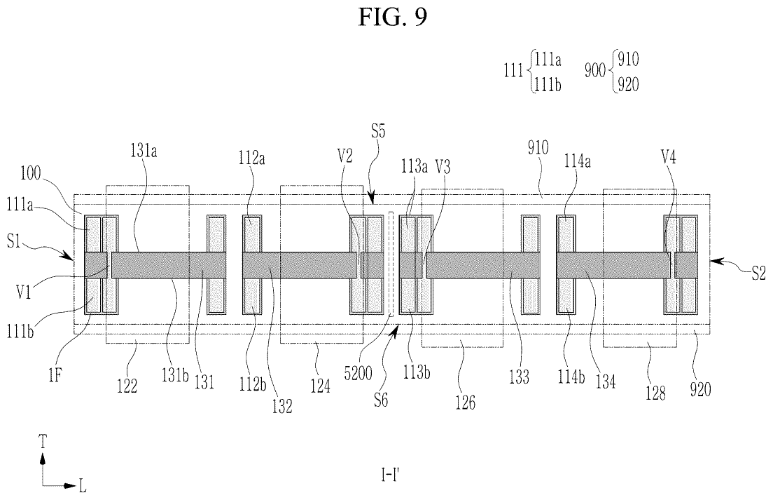

FIG. 9 schematically illustrates a cross-sectional view of a coil electronic component according to another embodiment.

Referring to FIG. 9, a gap portion 5200 is disposed between the second coil 112 and the third coil 113. No gap portions are disposed between the first coil 111 and the second coil 112 and between the third coil 113 and the fourth coil 114.

The gap portion 5200 is spaced apart from the outer surface of the body 100 and is disposed within the body 100.

The remaining components are identical to the components of the coil electronic component shown in FIG. 8, so repeated descriptions thereof will be omitted.

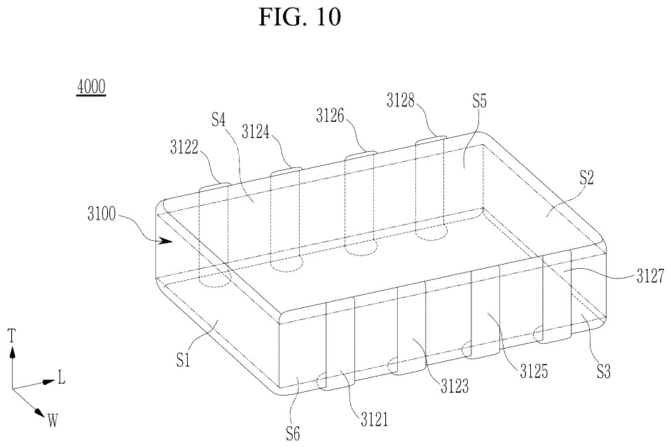

FIG. 10 schematically illustrates a perspective view of a coil electronic component according to another embodiment.

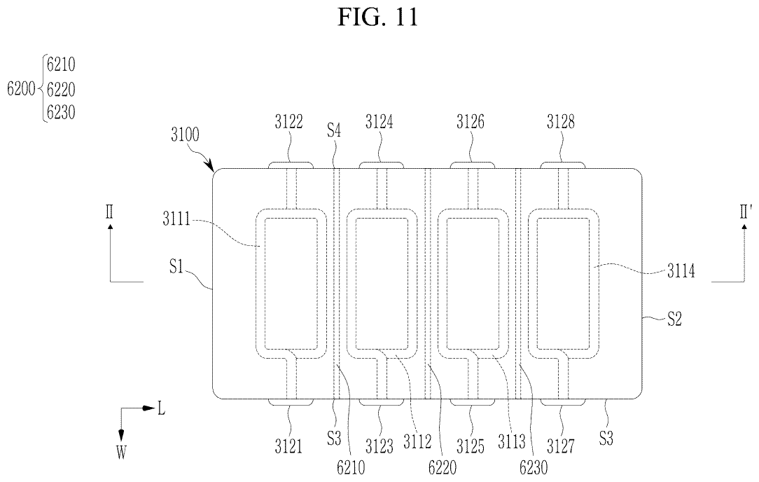

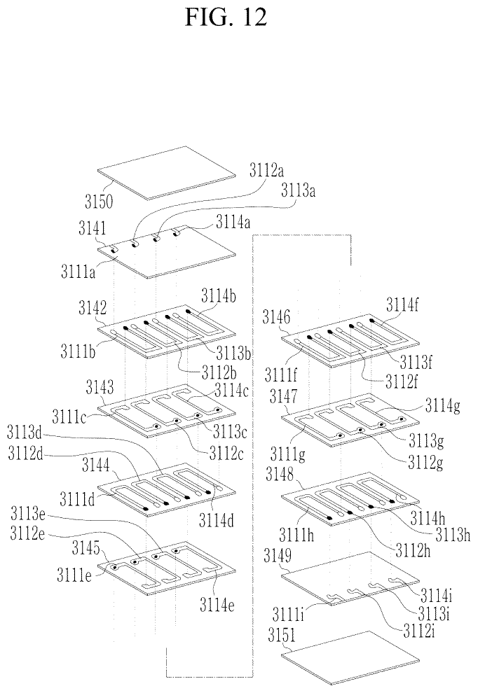

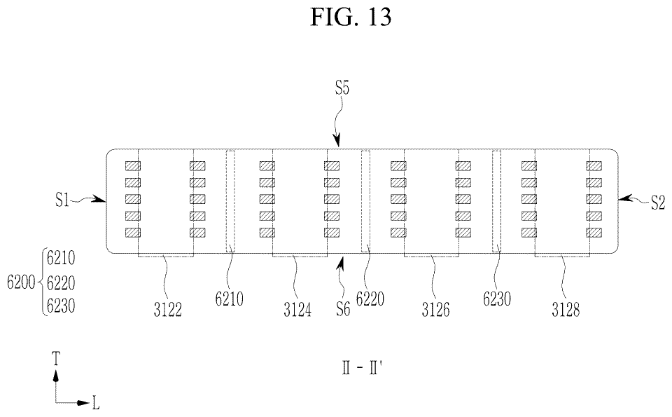

FIG. 11 illustrates a top plan view of FIG. 10, FIG. 12 illustrates an exploded perspective view of a body of the coil electronic component of FIG. 10, and FIG. 13 illustrates a schematic cross-sectional view taken along line II-II′ of FIG. 11.

Referring to FIG. 10, FIG. 11, and FIG. 13, a coil electronic component 4000 includes a body 3100, first to eighth external electrodes 3121, 3122, 3123, 3124, 3125, 3126, 3127, and 3128 disposed on an outer surface of the body 3100, a plurality of coils 3111, 3112, 3113, and 3114 embedded in the body 3100, and a gap portion 6200.

The first coil 3111, the second coil 3112, the third coil 3111, and the fourth coil 3114 are embedded in the body 3100. The winding axes of the first coil 3111, the second coil 3112, the third coil 3113 and the fourth coil 3114 may be parallel to the thickness direction (T-axis direction) of the body 3100.

The gap portion 6200 includes a first gap portion 6210, a second gap portion 6220, and a third gap portion 6230.

The first gap portion 6210 is disposed between the first coil 3111 and the second coil 3112, the second gap portion 6220 is disposed between the second coil 3112 and the third coil 3113, and the third gap portion 6230 is disposed between the third coil 3111 and the fourth coil 3114.

Referring to FIG. 12, the body 3100 may be a laminate made by stacking a plurality of magnetic sheets 3141, 3142, 3143, 3144, 3145, 3146, 3147, 3148, and 3149 on which conductor patterns 3111a to 3111i, 3112a to 3112i, 3113a to 3113i, and 3114a to 3114i comprising portions of the first to fourth coils 3111, 3112, 3113, and 3114 are disposed and a plurality of magnetic sheets 3150 and 3151 on which no conductor patterns are disposed in the thickness direction (T-axis direction).

A plurality of substantially J-shaped conductor patterns 3111a, 3112a, 3113a, and 3114a are formed on the magnetic sheet 3141. One end of each of the conductor patterns 3111a, 3112a, 3113a, and 3114a is drawn out from the edge of the magnetic sheet 3141 so as to be exposed from the fourth surface S4 of the body 3100.

A plurality of conductor patterns 3111b, 3112b, 3113b, and 3114b electrically connected to the respective conductor patterns 3111a, 3112a, 3113a, and 3114a are formed on the magnetic sheet 3142. The conductor patterns 3111b, 3112b, 3113b, and 3114b correspond to nearly ¾ of a turn of the first to fourth coils 3111, 3112, 3113, and 3114 and are in a substantially U-shape.

A plurality of conductor patterns 3111c, 3112c, 3113c, and 3114c electrically connected to the respective conductor patterns 3111b, 3112b, 3113b, and 3114b are formed on the magnetic sheet 3143. The conductor patterns 3111c, 3112c, 3113c, and 3114c correspond to nearly ¾ of a turn of the first to fourth coils 3111, 3112, 3113, and 3114 and are in a substantially C-shape.

A plurality of conductor patterns 3111d, 3112d, 3113d, and 3114d electrically connected to the respective conductor patterns 3111c, 3112c, 3113c, and 3114c are formed on the magnetic sheet 3144. The conductor patterns 3111d, 3112d, 3113d, and 3114d correspond to nearly ¾ of a turn of the first to fourth coils 3111, 3112, 3113, and 3114 and are in a substantially U-shape.

A plurality of conductor patterns 3111e, 3112e, 3113e, and 3114e electrically connected to the respective conductor patterns 3111d, 3112d, 3113d, and 3114d are formed on the magnetic sheet 3145. The conductor patterns 3111e, 3112e, 3113e, and 3114e correspond to nearly ¾ of a turn of the first to fourth coils 3111, 3112, 3113, and 3114 and are in a substantially C-shape.

A plurality of conductor patterns 3111f, 3112f, 3113f, and 3114f electrically connected to the respective conductor patterns 3111e, 3112e, 3113e, and 3114e are formed on the magnetic sheet 3146. The conductor patterns 3111f, 3112f, 3113f, and 3114f have the same structure as the conductor patterns 3111b, 3112b, 3113b, and 3114b described above.

A plurality of conductor patterns 3111g, 3112g, 3113g, and 3114g electrically connected to the respective conductor patterns 3111f, 3112f, 3113f, and 3114f are formed on the magnetic sheet 3147. The conductor patterns 3111g, 3112g, 3113g, and 3114g have the same structure as the conductor patterns 3111c, 3112c, 3113c, and 3114c described above.

A plurality of conductor patterns 3111h, 3112h, 3113h, and 3114h electrically connected to the respective conductor patterns 3111g, 3112g, 3113g, and 3114g are formed on the magnetic sheet 3148. The conductor patterns 3111h, 3112h, 3113h, and 3114h have the same structure as the conductor patterns 3111d, 3112d, 3113d, and 3114d described above.

A plurality of substantially J-shaped conductor patterns 3111i, 3112i, 3113i, and 3114i electrically connected to the respective conductor patterns 3111h, 3112h, 3113h, and 3114h are formed on the magnetic sheet 3149. One end of each of the conductor patterns 3111i, 3112i, 3113i, and 3114i is drawn out from the edge of the magnetic sheet 3149 so as to be exposed from the third surface S3 of the body 3100. In addition, electrical connections between conductor patterns on different magnetic sheets are made via through-holes (not shown) formed in the magnetic sheet.

By stacking the plurality of magnetic sheets 3141, 3142, 3143, 3144, 3145, 3146, 3147, 3148, and 3149 on which the conductor patterns 3111a to 3111i, 3112a to 3112i, 3113a to 3113i, and 3114a to 3114i are disposed, a body 3100 including first to fourth coils 3111, 3112, 3113, and 3114 may be formed. A gap portion 6200 may be formed by cutting the body between two adjacent coils of any of the first to fourth coils 3111, 3112, 3113, and 3114, forming a groove, and then filling the groove with glass. However, the present embodiment is not limited thereto, so the gap portion may be formed in various other methods.

The magnetic sheet 3150 on which no conductor pattern is disposed is stacked on the magnetic sheet 3141. The magnetic sheet 3150 protects the conductor patterns 3111a, 3112a, 3113a, and 3114a on the magnetic sheet 3141. In addition, another magnetic sheet 3151 on which no conductor pattern is disposed is disposed under the magnetic sheet 3149.

The number of magnetic sheets described above is by way of example only, and the present embodiment is not limited thereto.

Except for the components described above, the remaining components are identical to the components of the coil electronic component shown in FIG. 1, so repeated descriptions thereof will be omitted.

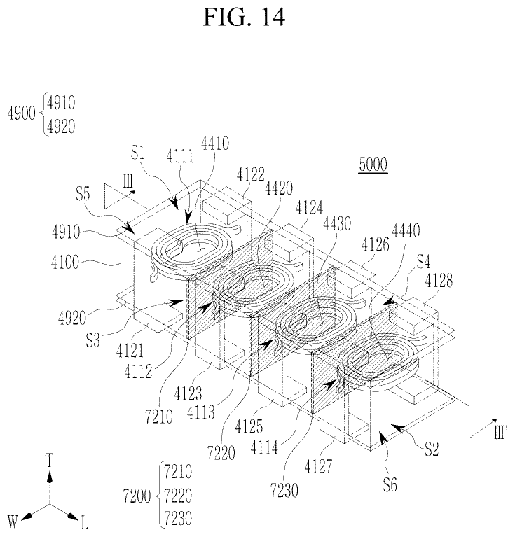

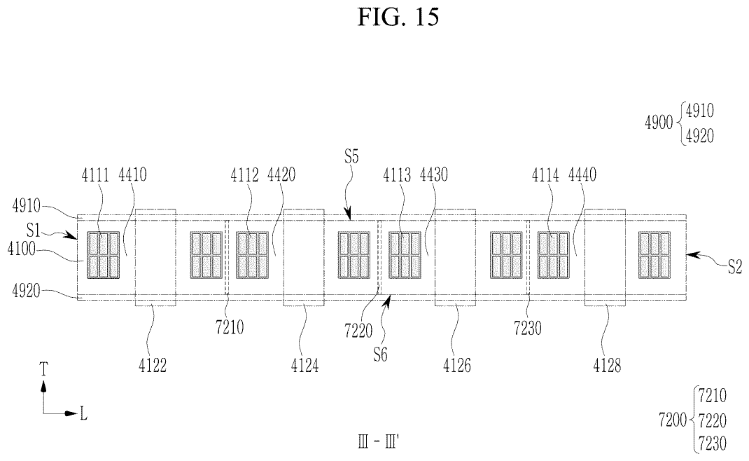

FIG. 14 schematically illustrates a perspective view of a coil electronic component according to another embodiment, and FIG. 15 illustrates a schematic cross-sectional view taken along line III-III′ of FIG. 14.

Referring to FIG. 14 and FIG. 15, a coil electronic component 5000 includes a body 4100, first to eighth external electrodes 4121, 4122, 4123, 4124, 4125, 4126, 4127, and 4128 disposed on an outer surface of the body 4100, a plurality of coils 4111, 4112, 4113, and 4114 embedded in the body 4100, and a gap portion 7200.

The first coil 4111, the second coil 4112, the third coil 4113, and the fourth coil 4114 are embedded in the body 4100. The body 4100 may include a first core 4410 penetrating the first coil 4111, a second core 4420 penetrating the second coil 4112, a third core 4430 penetrating the third coil 4413, and a fourth core 4440 penetrating the fourth coil 4414.

The first coil 4111 includes at least one turn of a conductive wire. An insulating film IF may be disposed on a surface of the first coil 4111.

The second coil 4112, the third coil 4113, and the fourth coil 4114 differ from the first coil 4111 only in their locations, so redundant descriptions thereof will be omitted.

The gap portion 7200 includes a first gap portion 7210, a second gap portion 7220, and a third gap portion 7230.

The first gap portion 7210 is disposed between the first coil 4111 and the second coil 4112, the second gap portion 7220 is disposed between the second coil 4112 and the third coil 4113, and the third gap portion 7230 is disposed between the third coil 4113 and the fourth coil 4114.

Meanwhile, a surface insulating layer 4900 is disposed on the fifth surface S5 and the sixth surface S6 of the body 4100.

The surface insulating layer 4900 includes a first insulating layer 4910 and a second insulating layer 4920. The first insulating layer 4910 is disposed on the fifth surface S5 of the body 4100, and the second insulating layer 4920 is disposed on the sixth surface S6 of the body 4100.

The remaining components are identical to the components of the coil electronic component shown in FIG. 1, so repeated descriptions thereof will be omitted.

### Preparation Example: Manufacture of Coil Electronic Component

### Example

A coil electronic component was manufactured with four coils spaced apart and embedded in a body and a glass gap portion disposed between the coils. The relative magnetic permeability of the body was 36 and the relative magnetic permeability of the gap portion was 1.

### Comparative Example

The comparative example was identical to Example 1 except that the coil electronic component did not include a gap portion.

### Experimental Example: Performance of Coil Electronic Components

After manufacturing fifty (50) pieces of each of coil electronic components according to Example and Comparative Example, the inductances of the first coil, the second coil, the third coil, and the fourth coil were measured, and the increase rates of the inductances of the second coil, the third coil, and the fourth coil were calculated based on the inductance of the first coil. The increase rate of the inductance of the second coil was calculated by subtracting the inductance of the first coil from the inductance of the second coil and by dividing the value obtained by the inductance of the first coil. The increase rates of the inductances of the third and fourth coils were calculated using the same method. The results are summarized in Table 1.

TABLE 1

| | | First | Second | Third | Fourth |
|---|---|---|---|---|---|
| | | coil | coil | coil | coil |
| Example | Inductance (uH) | 0.833 | 0.845 | 0.845 | 0.838 |
| | Inductance Increase | — | 1.44% | 1.44% | 0.60% |
| | Rate (%) | | | | |
| Comparative | Inductance (uH) | 0.813 | 0.861 | 0.861 | 0.827 |
| example | Inductance Increase | — | 5.96% | 5.94% | 1.76% |
| | Rate (%) | | | | |

Referring to Table 1, the inductance increase rates of the second and third coils of the coil electronic component according to Example were 1.44% each, and the inductance increase rate of the fourth coil was 0.60%. On the other hand, the inductance increase rates of the second and third coils of the coil electronic component according to Comparative Example were 5.96% and 5.94%, and the inductance increase rate of the fourth coil was 1.76%.

In the coil electronic component according to Example, the deviation between the inductances of the first and fourth coils and the inductances of the second and third coils was relatively small, whereas in the coil electronic component according to Comparative Example, the deviation between the inductances of the first and fourth coils and the inductances of the second and third coils was large. Because the coil electronic component according to Comparative Example did not include a gap portion, the inductance of the second and third coils is determined to have increased further due to interference of the crossing magnetic fluxes between the different coils.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A coil electronic component, comprising:
a body including a magnetic material,
four or more coils embedded in the body, and
a gap portion comprising a glass material disposed in at least one of regions between adjacent coils in the four or more coils.

2. The coil electronic component of claim 1, wherein
the gap portion includes a surface flush with an outer surface of the body.

3. The coil electronic component of claim 1, wherein
the four or more coils include a first coil, a second coil, a third coil, and a fourth coil that are spaced apart from each other,
the gap portion includes at least one of a first gap portion, a second gap portion, and a third gap portion,
the first gap portion is disposed in a first region between the first coil and the second coil,
the second gap portion is disposed in a second region between the second coil and the third coil, and
the third gap portion is disposed in at least one region of a third region between the third coil and the fourth coil.

4. The coil electronic component of claim 3, wherein
each of the first gap portion, the second gap portion, and the third gap portion includes a surface flush with an outer surface of the body.

5. The coil electronic component of claim 3, wherein
the first gap portion, the second gap portion, and the third gap portion are all spaced apart from an outer surface of the body.

6. The coil electronic component of claim 1, wherein
The four or more coils include a first coil, a second coil, a third coil, and a fourth coil that are spaced apart from each other, and
the gap portion includes
a first gap portion disposed in a first region between the first coil and the second coil, and
a third gap portion disposed in a third region between the third coil and the fourth coil,
wherein each of the first gap portion and the third gap portion includes a surface flush with an outer surface of the body.

7. The coil electronic component of claim 1, wherein
the four or more coils include a first coil, a second coil, a third coil, and a fourth coil that are spaced apart from each other, and
the gap portion includes
a first gap portion disposed in a first region between the first coil and the second coil, and
a third gap portion disposed in a third region between the third coil and the fourth coil,
wherein both the first gap portion and the third gap portion are spaced apart from an outer surface of the body.

8. The coil electronic component of claim 1, wherein
the four or more coils include a first coil, a second coil, a third coil, and a fourth coil that are spaced apart from each other, and
the gap portion is disposed in a second region between the second coil and the third coil, and includes a surface flush with an outer surface of the body.

9. The coil electronic component of claim 1, wherein
The four or more coils include a first coil, a second coil, a third coil, and a fourth coil that are spaced apart from each other, and
the gap portion is disposed in a second region between the second coil and the third coil, and is spaced apart from an outer surface of the body.

10. The coil electronic component of claim 1, further comprising:
a first support member, a second support member, a third support member, and a fourth support member that are embedded in the body and spaced apart from each other,
wherein the four or more coils include a first coil, a second coil, a third coil, and a fourth coil that are spaced apart from each other,
the first coil is disposed on the first support member,
the second coil is disposed on the second support member,
the third coil is disposed on the third support member, and
the fourth coil is disposed on the fourth support member.

11. The coil electronic component of claim 10, wherein
the first coil includes two coil patterns disposed on one surface and the other surface of the first support member, respectively, and connected to each other through a via penetrating the first support member,
the second coil includes two coil patterns disposed on one surface and the other surface of the second support member, respectively, and connected to each other through a via penetrating the second support member,
the third coil includes two coil patterns disposed on one surface and the other surface of the third support member, respectively, and connected to each other through a via penetrating the third support member, and
the fourth coil includes two coil patterns disposed on one surface and the other surface of the fourth support member, respectively, and connected to each other through a via penetrating the fourth support member.

12. The coil electronic component of claim 1, wherein
the body is a laminate comprising a plurality of magnetic sheets stacked together,
the four or more coils include a first coil, a second coil, a third coil, and a fourth coil that are spaced apart from each other, and
each of the first coil, the second coil, the third coil, and the fourth coil includes a plurality of conductor patterns disposed on each magnetic sheet of the plurality of magnetic sheets and connected to each other.

13. The coil electronic component of claim 1, wherein
the four or more coils include a first coil, a second coil, a third coil, and a fourth coil that are spaced apart from each other, and
each of the first coil, the second coil, the third coil, and the fourth coil includes at least one turn of a conductive wire.

14. The coil electronic component of claim 13, wherein
the body includes a first core penetrating the first coil, a second core penetrating the second coil, a third core penetrating the third coil, and a fourth core penetrating the fourth coil.

15. The coil electronic component of claim 13, further comprising:
an insulating film disposed on a surface of the conductive wire.

16. The coil electronic component of claim 1, wherein
a relative magnetic permeability of the gap portion is 1 or more and 3 or less.

17. The coil electronic component of claim 1, further comprising:
a plurality of external electrodes disposed outside the body and connected to the four or more coils.

18. The coil electronic component of claim 17, wherein
the plurality of external electrodes includes metal.

19. The coil electronic component of claim 18, wherein
the plurality of external electrodes further includes glass.

20. The coil electronic component of claim 1, further comprising:
a surface insulating layer covering at least a portion of a surface of the body.

21. A coil electronic component, comprising:
a body comprising a plurality of magnetic sheets stacked together,
a plurality of coils embedded in the body, wherein each respective coil in the plurality of coils comprises a plurality of corresponding conductor patterns disposed on the plurality of magnetic sheets and electrically connected to each other, and (ii) for each respective coil in the plurality of coils, at least three conductor patterns in the plurality of corresponding conductor patterns are different from each other in shape, and
one or more gap portions, each comprising a glass material disposed in a region between adjacent coils in the plurality of coils.

22. The coil electronic component of claim 21, wherein
coils in the plurality of coils are substantially identical.

23. The coil electronic component of claim 21, wherein
the plurality of coils comprises first, second, third and fourth coils, and
the one or more gap portions comprise a first gap portion disposed between the first and second coils, a second gap portion disposed between the second and third coils, and a third gap portion disposed between the third and fourth coils.

24. The coil electronic component of claim 21, wherein the plurality of corresponding conductor patterns comprises:
a first conductor pattern in a substantially J-shape with an end exposed to a surface of the body,
a second conductor pattern in a substantially U-shape, and
a third conductor pattern in a substantially C-shape.

25. The coil electronic component of claim 24, wherein the plurality of corresponding conductor patterns further comprises:
a fourth conductor pattern in a substantially reverted U-shape,
a fifth conductor pattern in a substantially reverted C-shape,
a sixth conductor pattern substantially the same as the second conductor pattern,
a seventh conductor pattern substantially the same as the third conductor pattern,
an eighth conductor pattern substantially the same as the fourth conductor pattern, and
a ninth conductor pattern in a substantially reverted J-shape with an end exposed to an opposite surface of the body.

26. The coil electronic component of claim 21, wherein
the plurality of corresponding conductor patterns comprises nine or more conductor patterns.

27. The coil electronic component of claim 21, wherein
the body further comprises two additional magnetic sheets, wherein the plurality of magnetic sheets is disposed between the two additional magnetic sheets.
